(19) United States
(12) Patent Application Publication
(10) Pub. No.: US 2015/0120562 A1
(43) Pub. Date: Apr. 30, 2015

(54) METHOD, APPARATUS, AND SYSTEM FOR SECURE PAYMENT

(71) Applicant: TENCENT TECHNOLOGY (SHENZHEN) COMPANY LIMITED, Shenzhen (CN)

(72) Inventor: YUMIAO ZHANG, Shenzhen (CN)

(73) Assignee: TENCENT TECHNOLOGY (SHENZHEN) COMPANY LIMITED

(21) Appl. No.: 14/583,961

(22) Filed: Dec. 29, 2014

Related U.S. Application Data
(63) Continuation of application No. PCT/CN2014/076767, filed on May 5, 2014.

(30) Foreign Application Priority Data
Oct. 30, 2013 (CN) 2013-10530089.8

(51) Int. Cl. G06Q 20/40

(52) U.S. Cl. CPC G06Q 20/4014
USPC 705/44

(57) ABSTRACT

Secure payment methods, apparatus, and systems are disclosed herein. A payment server receives a payment request submitted by a transaction client terminal, the payment request containing transaction ordering information and facial image information of a payer. The payment server obtains user identification information of the payer according to a recognition of the facial image information of the payer. The payment server obtains location information of the payer according to the user identification information of the payer. The payment server determines whether the payer is located within a transaction region of the transaction client terminal. The payment server processes a payment transaction, when the payer is determined to be located within the transaction region. The disclosed method solves problems including that the personal identity code is hard to be memorized and/or vulnerable to be stolen. Payment safety and transaction efficiency are therefore significantly improved.

### CROSS-REFERENCES TO RELATED APPLICATIONS

This application is a continuation application of PCT Patent Application No. PCT/CN2014/076767, filed on May 5, 2014, which claims priority to Chinese Patent Application No. 201310530089.8, filed on Oct. 30, 2013, the entire contents of which are incorporated herein by reference.

### FIELD OF THE DISCLOSURE

The present disclosure relates the field of computer network communications and, more particularly, relates to methods, apparatus, and systems for secure payment.

### BACKGROUND

Recently, the electronic commerce (e-commerce) payment systems are gaining more popularity because of consistent growth of online shopping and financial services. In order to complete electronic transactions, various types of e-commerce payment systems have been developed in recent years including credit cards, debit cards, saving cards, digital wallets, e-cash, mobile payment systems and electronic checks. Due to rapid spreading of mobile devices (e.g. smart phones), the e-commerce payment systems based on mobile devices become one of the hottest recent topics.

In order to build a successful e-commerce system, how to assure safety of payment data (e.g., personal identification information, payment details, and bank information) becomes a critical issue. Traditionally, the personal identity code (or password) is only known between the bank and the user. When a user requests to start an online transaction, the bank can confirm the identity of the user by verifying the personal identity code.

However, there are some drawbacks in the above described traditional verification process. First, it is hard for the user to memorize the personal identity code when the personal identification code is set overly complicated. On the other hand, when the personal identity code is set too simple, there is high risk to be cracked. Second, when a user enters a personal identity code on a mobile payment device, it is easy for the personal identity code to be spotted by others. The personal identity code may also be hacked, or stolen, or eavesdropped by malicious users when the mobile payment device is unprotected or the network connection to the bank platform is unsafe.

### BRIEF SUMMARY OF THE DISCLOSURE

According to various embodiments, there is provided a method for secure payment. A payment request submitted by a transaction client terminal is received by a payment server. The payment request contains transaction ordering information and facial image information of a payer currently acquired by the transaction client terminal. The payment server obtains user identification information of the payer according to a recognition of the facial image information of the payer and obtains location information of the payer according to the user identification information of the payer. The payment server determines whether the payer is located within a transaction region of the transaction client terminal according to the location information of the payer and processes a payment transaction according to the payment confirmation message returned from the payer, when the payer is determined to be located within the transaction region.

That the payment server obtains the user identification information of the payer according to the recognition of the facial image information of the payer includes calling pre-stored facial image information of a payment user, matching the recognition of the acquired facial image information of the payer with the pre-stored facial image information of the payment user, and acquiring user identification information corresponding to the facial image information of the payment user that is matched successfully as the user identification information of the payer. The pre-stored facial image information of the payment user corresponds to the user identification information of the payment user.

That the payment server obtains the location information of the payer according to the user identification information of the payer includes: sending a location request message to the payer according to the user identification information of the payer; and receiving the location information returned from the payer according to the location request message.

Alternatively, that the payment server obtains the location information of the payer according to the user identification information of the payer includes: timedly receiving the location information sent by the payer; and finding the location information of the payer from the received location information according to the user identification information of the payer.

That the payment server determines whether the payer is located within a transaction region of the transaction client terminal according to the location information of the payer includes: calling pre-stored transaction region information of the transaction client terminal, matching the acquired location information of the payer with the pre-stored transaction region information of the transaction client terminal, and when the matching is successful, determining that a location of the payer is within the transaction region of the transaction client terminal.

That the payment server processes the payment transaction according to the payment confirmation message returned from the payer includes: sending a payment confirmation requesting message to the payer according to the payment request, the payment confirmation requesting message containing the transaction ordering information; and processing the payment transaction according to the payment confirmation message returned from the payer.

A computer storage medium is configured to store a program and the program is executed according to the disclosed method for secure payment.

According to various embodiments, there is provided a method for secure payment by acquiring facial image information of a payer according to a payment instruction by a transaction client terminal. The payer is a current payer. The transaction client terminal then generates a payment request according to the facial image information of the payer. The payment request contains transaction ordering information and the facial image information of the payer currently acquired by the transaction client terminal. The transaction client terminal sends the payment request to a payment server for the payment server to obtain user identification information of the payer according to a recognition of the facial image information of the payer, to obtain location information of the payer according to the user identification information of the payer, to determine whether the payer is located within a transaction region of the transaction client terminal according to the location information of the payer, and to process a payment transaction according to a payment confirmation message returned from the payer, when the payer is determined to be located within the transaction region.

Optionally, the transaction client terminal reports location information of the transaction client terminal to the payment server for the payment server to store the location information of the transaction client terminal to form transaction region information of the transaction client terminal. A computer storage medium is configured to store a program and the program is executed according to the disclosed method for secure payment.

According to various embodiments, there is provided a payment server. The payment server includes a payment request receiving module, a recognizing module, a location information acquiring module, a determining module, and a payment processing module.

The payment request receiving module is configured to receive a payment request submitted by a transaction client terminal, the payment request containing transaction ordering information and facial image information of a payer currently acquired by the transaction client terminal. The recognizing module is configured to recognize the facial image information of the payer to obtain user identification information of the payer. The location information acquiring module is configured to acquire location information of the payer according to the user identification information of the payer. The determining module is configured to determine whether the payer is located within a transaction region of the transaction client terminal according to the location information of the payer. The payment processing module is configured to process a payment transaction according to a payment confirmation message returned from the payer, when the payer is determined to be located within the transaction region.

The recognizing module includes a facial image calling unit configured to call pre-stored facial image information of a payment user. The pre-stored facial image information of the payment user corresponds to the user identification information of the payment user. The recognizing module also includes a recognition matching unit configured to match the recognition of the facial image information of the payer with the pre-stored facial image information of the payment user and an acquiring unit configured, when the matching of the recognition is successful, to acquire user identification information corresponding to facial image information of a payment user that is matched successfully as the user identification information of the payer.

The location information acquiring module includes: a sending and receiving unit configured to send a location request message to the payer according to the user identification information of the payer; and to receive the location information returned from the payer according to the location request message.

The location information acquiring module includes: a receiving and finding unit configured to timedly receive the location information sent by the payer; and to find the location information of the payer from the received location information according to the user identification information of the payer.

The determining module includes a transaction region calling unit configured to call pre-stored transaction region information of the transaction client terminal. The determining module also includes a matching and determining unit configured to match the acquired location information of the payer with the pre-stored transaction region information of the transaction client terminal, and, when the matching is successful, to determine that a location of the payer is within the transaction region of the transaction client terminal.

The payment processing module includes a payment confirmation sending unit configured to send a payment confirmation requesting message to the payer according to the payment request, the payment confirmation requesting message containing the transaction ordering information. The payment processing module also includes a payment confirmation processing unit configured to process the payment transaction according to the payment confirmation message returned from the payer.

According to various embodiments, there is provided a transaction client terminal including a facial image information acquiring module, a payment request generating module, and a payment request sending module.

The facial image information acquiring module is configured to acquire facial image information of a payer according to a payment instruction. The payer is a current payer. The payment request generating module is configured to generate a payment request according to the facial image information of the payer, the payment request containing transaction ordering information and the facial image information of the payer currently acquired by the transaction client terminal. The payment request sending module is configured to send the payment request to a payment server according to the payment instruction for the payment server to obtain user identification information of the payer according to a recognition of the facial image information of the payer, to obtain location information of the payer according to the user identification information of the payer, to determine whether the payer is located within a transaction region of the transaction client terminal according to the location information of the payer, and to process a payment transaction according to a payment confirmation message returned from the payer, when the payer is determined to be located within the transaction region.

The transaction client terminal further includes a location reporting module configured to report location information of the transaction client terminal to the payment server for the payment server to store the location information of the transaction client terminal to form transaction region information of the transaction client terminal.

According to various embodiments, there is provided a secure payment system, including a payment server and a transaction client terminal. The transaction client terminal is configured to acquire facial image information of the payer according to the payment instruction, to generate the payment request according to the facial image information of the payer, the payment request containing the transaction ordering information and the facial image information of the payer currently acquired by the transaction client terminal; and to send the payment request to the payment server.

The payment server is configured to receive the payment request submitted by the transaction client terminal, to obtain the user identification information of the payer according to the recognition of the facial image information of the payer, to acquire the location information of the payer according to the user identification information of the payer, to determine whether the payer is located within the transaction region of the transaction client terminal according to the location information of the payer; and to process the payment transaction according to the payment confirmation message returned from the payer, when the payer is determined to be located within the transaction region.

The payer uses a mobile terminal adapted with the disclosed secure payment methods, devices, and systems. The mobile terminal is configured to provide the location information of the payer to the payment server.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary secure payment method consistent with various disclosed embodiments;

FIG. 2 depicts another exemplary secure payment method consistent with various disclosed embodiments;

FIG. 3 depicts another exemplary secure payment method consistent with various disclosed embodiments;

FIG. 4 depicts an exemplary payment server consistent with various disclosed embodiments;

FIG. 5 depicts an exemplary recognizing module consistent with various disclosed embodiments;

FIG. 6 depicts an exemplary location acquiring module consistent with various disclosed embodiments;

FIG. 7 depicts an exemplary determining module consistent with various disclosed embodiments;

FIG. 8 depicts an exemplary payment processing module consistent with various disclosed embodiments;

FIG. 9 depicts another exemplary payment server consistent with various disclosed embodiments;

FIG. 10 depicts an exemplary transaction client terminal consistent with various disclosed embodiments;

FIG. 11 depicts another exemplary transaction client terminal consistent with various disclosed embodiments;

FIG. 12 depicts an exemplary secure payment system consistent with various disclosed embodiments; and

FIG. 13 depicts another exemplary secure payment system consistent with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

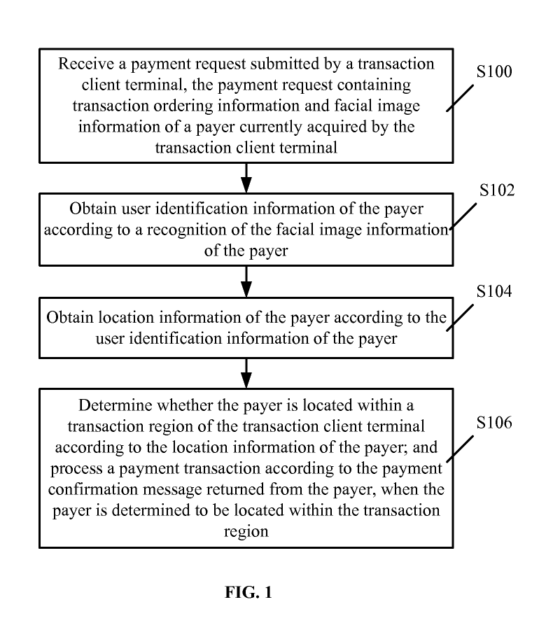

FIG. 1 depicts an exemplary secure payment consistent with various disclosed embodiments.

In Step S100, the payment server receives a payment request submitted by a transaction client terminal. The payment request contains transaction ordering information and facial image information of a payer currently acquired by the transaction client terminal.

For example, when a payer (or a user such as a payment user) needs to purchase an item or a service in a store, the transaction client terminal located in the store may take the facial image information of the payer through a camera device or a facial scanning device, and may generate a payment request containing the transaction ordering information and the facial image information, and then send the payment request to the payment server.

In Step S102, the payment server obtains user identification information of the payer according to recognition of the facial image information of the payer. For example, the facial image information of each user corresponds to identification information of the user, which includes, e.g., account ID information of the corresponding user, or mobile number information, or personal email information of that user.

In Step S104, the payment server obtains location information of the payer according to the user identification information of the payer. For example, the payment server can confirm which user is the payer for a current transaction (or a current payer) according to the user-specific identification information. In addition, the payment server can obtain the specific location information of a current user corresponding to the payer.

In Step S106, the payment server determines whether the payer is located within the transaction region of the transaction client terminal according to the location information of the payer. Then the payment server processes the payment transaction according to the payment confirmation message returned from the payer when the payer is determined to be located within the transaction region.

For example, the user of the transaction client terminal can include a merchant being paid in this transaction. Specifically, the database of the payment server can pre-store merchant information of every participating merchant in advance. The pre-store merchant information may include, e.g., type of merchandise of the merchant, merchant location, and/or information of the promotion activities of the merchant. The database of the payment server can also pre-store transaction region information of the transaction client terminal of every participating merchant.

The transaction region information can include, for example, the specific geographical coordinates previously reported by the merchant and a surrounding area within 100 meters from the coordinates that can be considered as the transaction region of the transaction client terminal.

The payment server may only recognize transaction activities that occur within the transaction regions pre-stored in the database of the payment server. After obtaining a current location of the payer, the payment server can determine whether the current location of the corresponding user of the payer is within the transaction region of the transaction client terminal. When the payer is determined to be located within the transaction region, the transaction condition is considered as met, and the payment server can process the transaction payment of the payment request according to the payment conformation information.

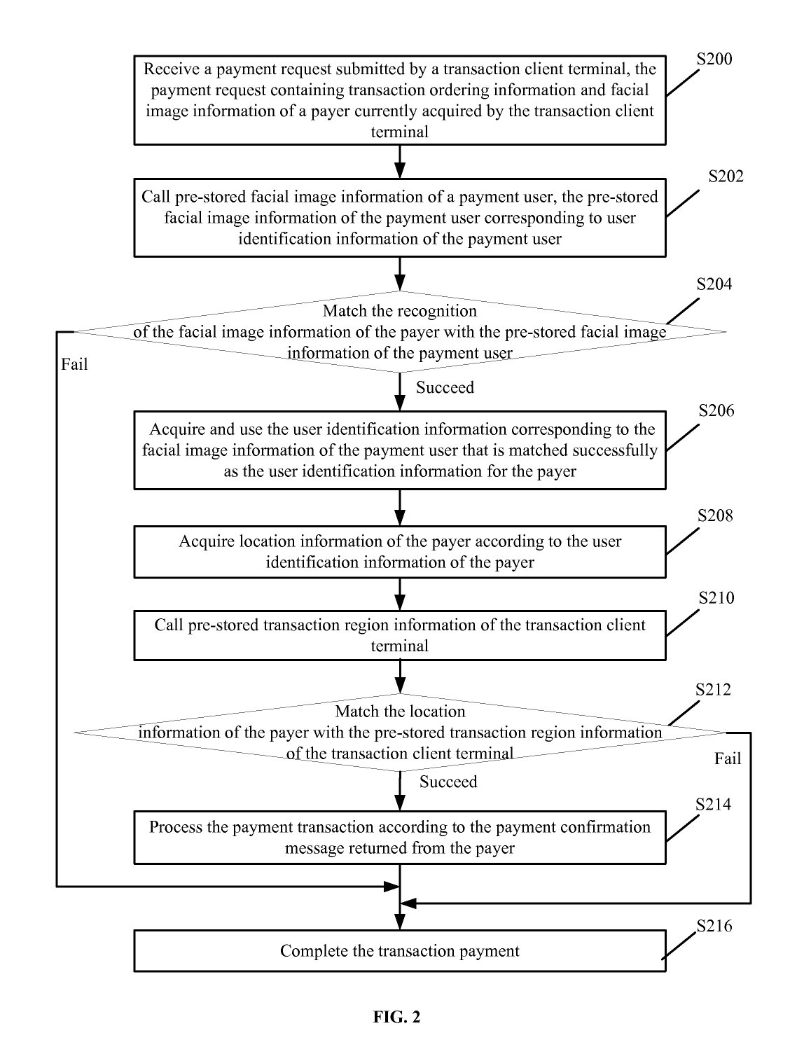

FIG. 2 depicts another exemplary secure payment method consistent with various disclosed embodiments.

In Step S200, a payment server receives a payment request submitted by a transaction client terminal, the payment request containing transaction ordering information and facial image information of a payer currently acquired by the transaction client terminal. In various embodiments, this step can be performed similarly or the same as for Step S100 of FIG. 1.

In Step S202, the payment server calls pre-stored facial image information of a payment user. The pre-stored facial image information of the payment user corresponds to user identification information of the payment user.

For example, the database of the payment server has pre-stored facial image information of every user. Each user's facial image information corresponds to that user's identification information including, e.g., account ID information of the corresponding user, or mobile number information, or personal email information of that user.

In Step S204, the payment server matches the recognition of the acquired facial image information of the payer with the pre-stored facial image information of the payment user.

For example, when the matching of the recognition is successful, the method then proceeds to perform Step S206. When the matching of the recognition fails, indicating the database of the payment server does not contain the facial image information of current payment user (for example, the payer has not registered yet, or the user's registration information is incomplete resulting in the absence of the facial image information of the user), the current payment transaction is considered to be failed and the method then proceed to perform Step S216. Transaction failure information may then be returned to the transaction client terminal.

In Step S206, when the matching of the recognition is successful, the user identification information corresponding to the facial image information of the payment user that is matched successfully is acquired and used as the user identification information for the payer.

In Step S208, the payment server acquires location information of the payer according to the user identification information of the payer.

In one example, the payment server can send a location request message to the payer according to the user identification information of the payer and can receive the location information returned by the payer according to the location request message. In one embodiment, the payment server can send a location request message to the payer through a mutual pre-decided software platform (e.g., a real-time communication platform, a social platform, and/or a transaction platform), and then receive the returned location information from the payer according to the location request.

In another example, the payment server can receive the location information sent by the payer timedly (e.g., regularly). The payment server can find the location information of the payer from received location information according to the user identification information of the payer. In various embodiments, the payer can send own location information to the payment server automatically and regularly through mutual pre-decided software platforms (e.g., a real-time communication platform, a social platform, and/or a transaction platform). According to the user identification information of the current payer, the payment server can search the location information of the current payer (i.e. the current payment user) from the received location information of the payers.

In Step S210, the payment server calls pre-stored transaction region information of the transaction client terminal.

For example, the user of the transaction client terminal can include a merchant being paid in this transaction. Specifically, the database of the payment server can pre-store merchant information of every participating merchant in advance. The pre-store merchant information may include, e.g., type of merchandise of the merchant, merchant location, and/or information of the promotion activities of the merchant. The database of the payment server can also pre-store transaction region information of the transaction client terminal of every participating merchant. The transaction region information can include, for example, the specific geographical coordinates previously reported by the merchant and a surrounding area within 100 meters from the coordinates that can be considered as the transaction region of the transaction client terminal.

In Step S212, the acquired location information of the payer is matched with the pre-stored transaction region information of the transaction client terminal.

For example, when the matching is successful, the method proceeds to perform Step S214. When the matching fails, indicating the current transaction location is not within the transaction region of the transaction client terminal stored in the database, that is, the current transaction payment fails and the method proceeds to perform Step S216. Transaction failure information can then be returned to the transaction client terminal.

In Step S214, when the matching is successful, indicating that the location of the payer is within the transaction region of the transaction client terminal, the payment server processes the payment transaction according to the payment confirmation message returned from the payer.

For example, the payment server can send a payment confirmation requesting message to the payer according to the payment request, the payment confirmation requesting message containing the transaction ordering information. The payment server can process the payment transaction according to the payment confirmation message returned from the payer.

In Step S216, the transaction payment is completed.

As disclosed, by containing the facial image information of the payer in the payment request, and by recognizing and confirming the transaction region to perform the payment process, double safety verification can be provided through the facial image information and through the location information of the payer. In addition, only after the double safety verification, the operation of the payment process can be allowed. The disclosed methods thus solve problems including that the personal identity code is hard to be memorized and/or vulnerable to be stolen. Payment safety is therefore significantly improved. During the transaction process, the user can complete the payment process without operations including entering the personal identity code, etc. The transaction payment process is more convenient and the payment efficiency is improved.

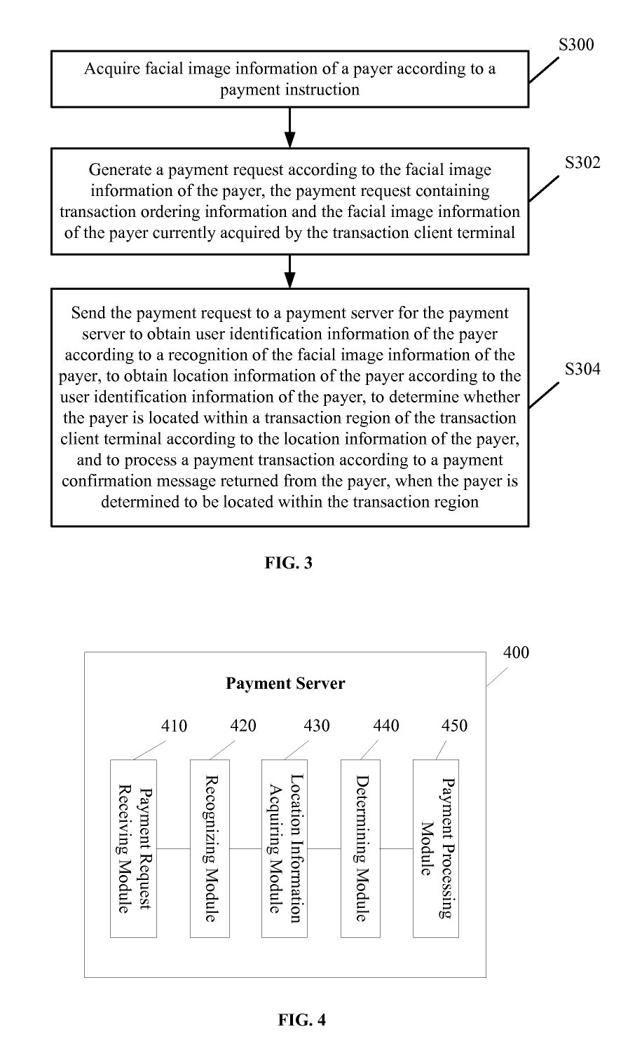

FIG. 3 depicts another exemplary secure payment method consistent with various disclosed embodiments.

In Step S300, a transaction client terminal acquires facial image information of a payer, e.g., a current payer. For example, when a payer (or a user such as a payment user) needs to purchase an item or a service in a store, the transaction client terminal located in the store may take the facial image information of the payer through a camera device or a facial scanning device.

In Step S302, the transaction client terminal generates a payment request according to the facial image information of the payer. The payment request contains the transaction ordering information and the facial image information of the payer currently acquired by the transaction client terminal.

In Step S304, the transaction client terminal sends the payment request to a payment server for the payment server to obtain user identification information of the payer according to a recognition of the facial image information of the payer, to obtain location information of the payer according to the user identification information of the payer, to determine whether the payer is located within a transaction region of the transaction client terminal according to the location information of the payer, and to process a payment transaction according to a payment confirmation message returned from the payer, when the payer is determined to be located within the transaction region.

For example, the payment server obtains the user identification information according to the facial image information of the payer, and completes the operations of the payment process of the payment request. These operations can be referred to the embodiments depicted in FIG. 1 and FIG. 2.

Further, the transaction client terminal reports location information of the transaction client terminal to the payment server for the payment server to store the location information of the transaction client terminal to form transaction region information of the transaction client terminal.

For example, the transaction client terminal may report own location information to the payment server through a mutual pre-decided software platform (e.g., a transaction platform), so as to indicate this transaction client terminal is a participating merchant. Transaction activities occurred within the region corresponding to the transaction region information can then be recognized by the payment server.

FIG. 4 depicts an exemplary payment server consistent with various disclosed embodiments. The exemplary payment server 400 includes: a payment request receiving module 410, a recognizing module 420, a location information acquiring module 430, a determining module 440, and a payment processing module 450.

The payment request receiving module 410 is configured to receive a payment request submitted by a transaction client terminal, the payment request containing transaction ordering information and facial image information of a payer currently acquired by the transaction client terminal.

For example, when a payer (or a user such as a payment user) needs to purchase an item or a service in a store, the transaction client terminal located in the store may take the facial image information of the payer through a camera device or a facial scanning device and generate a payment request according to the facial image information of the payer. The payment request contains the transaction ordering information and the facial image information of the payer currently acquired by the transaction client terminal and can be sent to the payment server. The payment request receiving module 410 then receives the payment request submitted by the transaction client terminal,

The recognizing module 420 is configured to recognize the facial image information of the payer to obtain user identification information of the payer. For example, the facial image information of each user corresponds to identification information of the user, which includes, e.g., account ID information of the corresponding user, or mobile number information, or personal email information of that user.

The location information acquiring module 430 is configured to acquire location information of the payer according to the user identification information of the payer. For example, the recognizing module 420 can confirm which user is the payer for a current transaction (or a current payer) according to the user-specific identification information. The recognizing module 420 can obtain the specific location information of a current user corresponding to the payer through the location information acquiring module 430.

The determining module 440 is configured to determine whether the payer is within a transaction region of the transaction client terminal according to the location information of the payer.

For example, the user of the transaction client terminal can include a merchant being paid in this transaction. Specifically, the database of the payment server can pre-store merchant information of every participating merchant in advance. The pre-store merchant information may include, e.g., type of merchandise of the merchant, merchant location, and/or information of the promotion activities of the merchant. The database of the payment server can also pre-store transaction region information of the transaction client terminal of every participating merchant.

The transaction region information can include, for example, the specific geographical coordinates previously reported by the merchant and a surrounding area within 100 meters from the coordinates that can be considered as the transaction region of the transaction client terminal. The payment server may only recognize transaction activities that occur within the transaction regions pre-stored in the database of the payment server. After the location information acquiring module 430 obtains a current location of the payer, the determining module 440 can determine whether the current location of the corresponding user of the payer is within the transaction region of the transaction client terminal. When the payer is determined to be located within the transaction region, the transaction condition is met.

The payment processing module 450 is configured to process the payment transaction according to a payment confirmation message returned from the payer, when the payer is determined to be located within the transaction region.

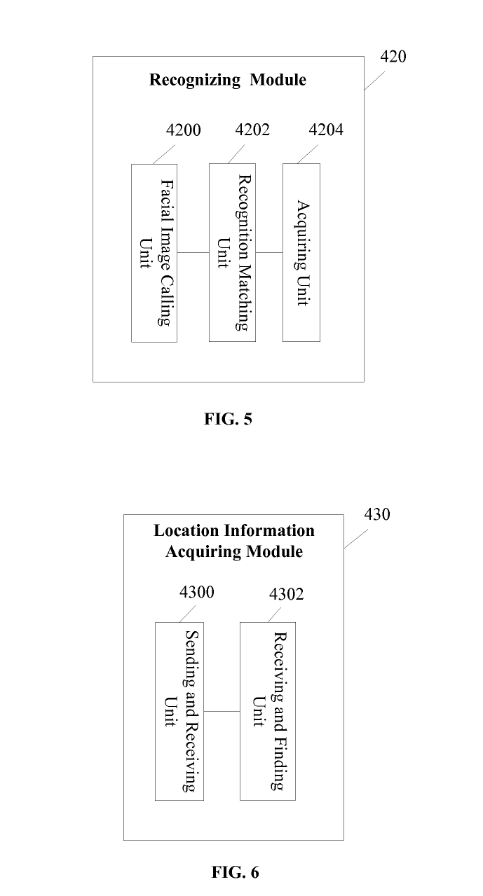

FIG. 5 depicts an exemplary recognizing module consistent with various disclosed embodiments. The exemplary recognizing module 420 can be configured in the payment server 400. The recognizing module 420 can include: a facial image calling unit 4200, a recognition matching unit 4202, and/or an acquiring unit 4204.

The facial image calling unit is configured to call pre-stored facial image information of a payment user. The pre-stored facial image information of the payment user corresponds to the user identification information of the payment user.

For example, the database of the payment server 400 can have pre-stored facial image information of every user. Each user's facial image information corresponds to that user's identification information including, e.g., account ID information of the corresponding user, or mobile number information, or personal email information of that user.

The recognition matching unit 4202 is configured to match the recognition of the facial image information of the payer with the pre-stored facial image information of the payment user.

For example, when the recognition matching unit 4202 succeeds in matching the recognition, the acquiring unit 4204 can be triggered to operate. When the recognition matching unit 4202 fails in matching the recognition, indicating the database of the payment server does not contain the facial image information of current payment user (for example, the payer has not registered yet, or the user's registration information is incomplete resulting in the absence of the facial image information of the user), the current payment transaction is considered to be failed and the payment server 400 is triggered to return transaction failure information to the transaction client terminal.

The acquiring unit 4204 is configured, when the matching of the recognition is successful, to acquire user identification information corresponding to facial image information of a payment user that is matched successfully as the user identification information of the payer.

FIG. 6 depicts an exemplary location acquiring module consistent with various disclosed embodiments. The exemplary location information acquiring module 430 can be used in the payment server 400. The exemplary location information acquiring module 430 can include: a sending and receiving unit 4300 and/or a receiving and finding unit 4302. In various embodiments, the sending and receiving unit 4300 and the receiving and finding unit 4302, either alone or in combination, can be included in the exemplary location information acquiring module 430.

The sending and receiving unit 4300 is configured to send a location request message to the payer according to the user identification information of the payer, and to receive the location information returned from the payer according to the location request message.

For example, the sending and receiving unit 4300 sends the location request message to the payer according to the user identification information of the payer, and the sending and receiving unit 4300 receives the location information returned by the payer according to the location request message. For example, the sending and receiving unit 4300 sends a location request message to the payer through a mutual pre-decided software platform (e.g., a real-time communication platform, a social platform, and/or a transaction platform), and then receives the returned location information from the payer according to the location request.

The receiving and finding unit 4302 is configured to timedly (e.g., regularly) receive the location information sent by the payer; and to find the location information of the payer from the received location information according to the user identification information of the payer.

For example, the receiving and finding unit 4302 can receive the location information sent by the payer timedly or regularly. The receiving and finding unit 4302 can find the location information of the payer from the received location information according to the user identification information of the payer. For example, the payer can send own location information to the payment server 400 automatically and/or regularly through the mutual pre-decided software platform (e.g., a real-time communication platform, a social platform, and/or a transaction platform). According to the user identification information of the current payer, the receiving and finding unit 4302 can search the location information of the current payer (i.e. the current payment user) from the received location information of the payers.

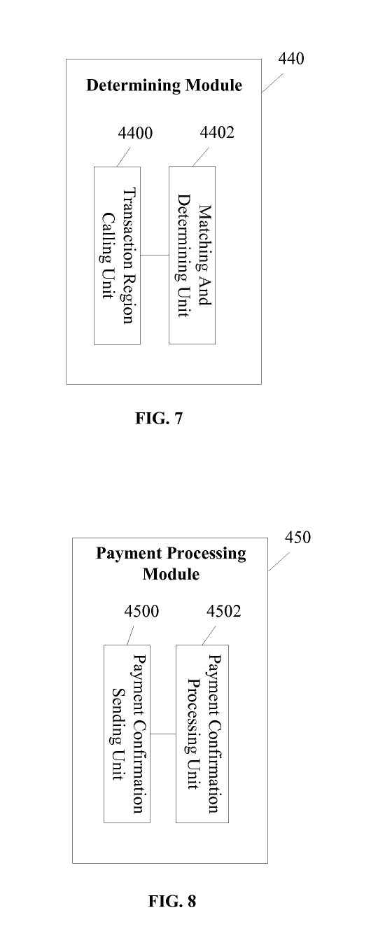

FIG. 7 depicts an exemplary determining module consistent with various disclosed embodiments. The exemplary determining module 440 can be configured in the payment server 400. The exemplary determining module 440 can include a transaction region calling unit 4400 and/or a matching and determining unit 4402.

The transaction region calling unit 4400 is configured to call pre-stored transaction region information of the transaction client terminal.

For example, the database of the payment server 400 can have pre-stored transaction region information of every transaction client terminal in advance. For example, the database of the payment server 400 can have pre-stored transaction region information of every participating merchant in advance (e.g., region information of the transaction client terminal of the merchant). The payment server only recognizes transaction activities that occur within the transaction regions pre-stored in the database.

The matching and determining unit 4402 is configured to match the acquired location information of the payer with the pre-stored transaction region information of the transaction client terminal, and, when the matching is successful, to determine that a location of the payer is within the transaction region of the transaction client terminal.

FIG. 8 depicts an exemplary payment processing module consistent with various disclosed embodiments. The exemplary payment processing module 450 can be configured in the payment server 400. The exemplary payment processing module 450 can include a payment confirmation sending unit 4500, and/or a payment confirmation processing unit 4502.

The payment confirmation sending unit 4500 is configured to send a payment confirmation requesting message to the payer according to the payment request, the payment confirmation requesting message containing the transaction ordering information.

The payment confirmation processing unit 4502 is configured to process the payment transaction according to the payment confirmation message returned from the payer.

As disclosed, by containing the facial image information of the payer in the payment request, and by recognizing and confirming the transaction region to perform the payment process, double safety verification can be provided through the facial image information and through the location information of the payer. In addition, only after the double safety verification, the operation of the payment process can be allowed. The disclosed methods thus solve problems including that the personal identity code is hard to be memorized and/or vulnerable to be stolen. Payment safety is therefore significantly improved. During the transaction process, the user can complete the payment process without operations including entering the personal identity code, etc. The transaction payment process is more convenient and the payment efficiency is improved.

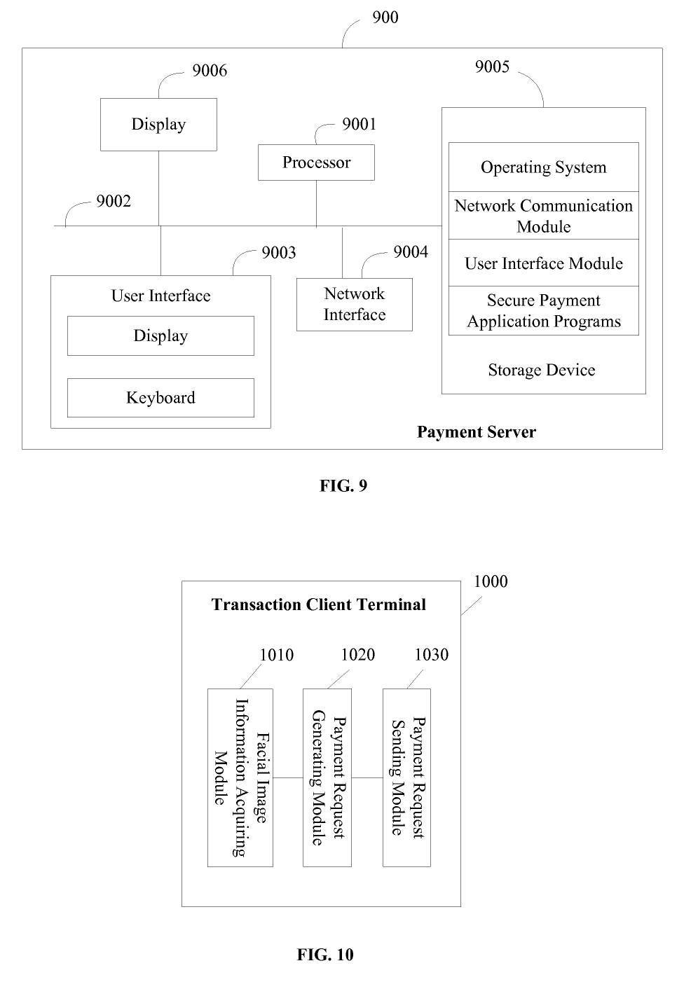

FIG. 9 depicts another exemplary payment server consistent with various disclosed embodiments. As depicted in FIG. 9, the exemplary payment server 900 can include: at least one processor 9001 (e.g. a CPU) at least one network interface 9004, a user interface 9003, a storage device 9005, at least one communication bus 9002, and/or a display 9006.

The communication bus 9002 is configured to implement communication connections between components. The user interface 9003 may include a display, and/or a keyboard. Optionally, the user interface 9003 may also include a standard wired interface, and a wireless interface. Optionally, the network interface 9004 may include a standard wired interface, and a wireless interface (e.g. a WI-FI interface). The storage device 9005 may include a high speed RAM memory, or a non-volatile memory, e.g. at least one disk storage device. Optionally, the storage device 9005 may include at least one storage device that is located far away from the above processor 9001. As shown in FIG. 9, as a computer storage medium, the storage device 9005 may include an operating system, a network communication module, a user interface module, and/or secure payment application programs.

In the payment server 9000 depicted in FIG. 9, the network interface 9004 can be connected to a transaction client terminal and a mobile terminal of a payer to process data communication between the transaction client terminal and the mobile terminal of the payer. The processor 9001 can be used to call the secure payment application programs stored in storage device 9005, and to execute operations as follows.

The processor 9001 can receive a payment request submitted by the transaction client terminal through the network interface 9004. The payment request contains transaction ordering information and facial image information of the payer currently acquired by the transaction client terminal. The processor 9001 can obtain user identification information of the payer according to recognition of the facial image information of the payer. The processor 9001 can acquire location information of the payer according to the user identification information of the payer. The processor 9001 can determine whether the payer is located within a transaction region of the transaction client terminal according to the location information of the payer. The processor 9001 can process a payment transaction according to the payment confirmation message returned from the payer, when the payer is determined to be located within the transaction region.

Further, the processor 9001 can call the secure payment application programs stored in storage device 9005, and to execute operations as follows. The processor 9001 can call pre-stored facial image information of a payment user. The pre-stored facial image information of the payment user corresponds to user identification information of the payment user.

The processor 9001 can match the recognition of the acquired facial image information of the payer with the pre-stored facial image information of the payment user. When the matching of the recognition is successful. The processor 9001 can acquire user identification information corresponding to the facial image information of the payment user that is matched successfully as the user identification information of the payer. When the matching of the recognition fails, indicating the database of the payment server does not contain the facial image information of current payment user (for example, the payer has not registered yet, or the user's registration information is incomplete resulting in the absence of the facial image information of the user), the current payment transaction is considered to be failed. The processor 9001 can return transaction failure information to the transaction client terminal via the network interface 9004.

Further, the processor 9001 can also call the secure payment application programs stored in the storage device 9005, and to execute operations as follows. The processor 9001 can call pre-stored transaction region information of the transaction client terminal.

The processor 9001 can match the acquired location information of the payer with the pre-stored transaction region information of the transaction client terminal. When the matching is successful, the processor 9001 can determine that a location of the payer is within the transaction region of the transaction client terminal. When the matching fails, indicating the current transaction location is not within the transaction region of the transaction client terminal stored in the database, that is, the current transaction payment fails. The processor 9001 can return transaction failure information to the transaction client terminal through the network interface 9004.

As such, the exemplary payment server depicted in FIG. 9 can achieve the double safety verification through the facial image information and through the location information of the payer. In addition, only after the double safety verification, the operation of the payment process can be allowed. The payment security can be significantly improved. Further, the exemplary payment server depicted in FIG. 9 can allow the payment methods to be performed with eliminated, tedious operations caused by manual input of payment password(s) by the payer. The payment operation can be simplified. Payment efficiency can be improved.

FIG. 10 depicts an exemplary transaction client terminal consistent with various disclosed embodiments. The transaction client terminal 1000 includes: a facial image information acquiring module 1010, a payment request generating module 1020, and a payment request sending module 1030.

The facial image information acquiring module 1010 is configured to acquire facial image information of a payer according to a payment instruction. The payer is a current payer. For example, when a payer (or a user such as a payment user) needs to purchase an item or a service in a store, the facial image information acquiring module 1010 may take the facial image information of the payer through a camera device or a facial scanning device.

The payment request generating module 1020 is configured to generate a payment request according to the facial image information of the payer, the payment request contains transaction ordering information and the facial image information of the payer currently acquired by the transaction client terminal.

The payment request sending module 1030 is configured to send the payment request to a payment server according to the payment instruction for the payment server to obtain user identification information of the payer according to a recognition of the facial image information of the payer, to obtain location information of the payer according to the user identification information of the payer, to determine whether the payer is located within a transaction region of the transaction client terminal according to the location information of the payer, and to process a payment transaction according to a payment confirmation message returned from the payer, when the payer is determined to be located within the transaction region. For example, the payment server can be the payment server 400 as disclosed above.

Further, the transaction client terminal 1000 of the present disclosure may also include a location reporting module configured to report location information of the transaction client terminal to the payment server for the payment server to store the location information of the transaction client terminal to form transaction region information of the transaction client terminal.

For example, the transaction client terminal 1000 may report the location information of the transaction client terminal to the payment server through the mutual pre-decided software platform (e.g. a transaction platform), so as to indicate this terminal is a participating merchant. Transaction activities occurred within current location can then be recognized by the payment server.

FIG. 11 depicts another exemplary transaction client terminal consistent with various disclosed embodiments. As depicted in FIG. 11, the exemplary transaction client terminal 1100 can include: at least one processor 11001, e.g. a CPU, at least one network interface 11004, a user interface 11003, a storage device 11005, at least one communication bus 11002, a display 11006, and camera/Scanner 1107.

The communication bus 11002 is configured to implement the communication connections among these components. The user interface 11003 may include a display, a keyboard. Optionally, the user interface 11003 may also include a standard wired interface, and a wireless interface. Optionally, the network interface 11004 may include a standard wired interface, and a wireless interface (e.g. a WI-FI interface). The storage device 11005 may include a high speed RAM memory, or a non-volatile memory, e.g. at least one disk storage device. Optionally, the storage device 11005 may include at least one storage device that is located far away from the above processor 11001. As shown in FIG. 11, as a computer storage medium, the storage device 1105 may include an operating system, a network communication module, a user interface module, and/or transaction payment application programs.

In the client terminal 11000 depicted in FIG. 11, the network interface 11004 can be connected to a payment server and a mobile terminal of a payer to process data communication between the payment server and the mobile terminal of the payer. The processor 11001 can be used to call the transaction payment application programs stored in storage device 1105, and to execute operations as follow:

The processor 11001 can acquire facial image information of a payer according to a payment instruction. The payer is a current payer.

The processor 1101 can acquire the current facial image information of the payer through the camera/scanner 11007 according to the payment instruction.

The processor 1101 can generates a payment request according to the facial image information of the payer, the payment request containing transaction ordering information and the facial image information of the payer currently acquired by the transaction client terminal 1100.

The processor 1101 can, through the network interface 11004, send the payment request to a payment server for the payment server to obtain user identification information of the payer according to a recognition of the facial image information of the payer, to obtain location information of the payer according to the user identification information of the payer, to determine whether the payer is located within a transaction region of the client terminal according to the location information of the payer, and to process a payment transaction according to a payment confirmation message returned from the payer, when the payer is determined to be located within the transaction region.

Further, processor 11001 can also call the transaction payment application programs stored in the storage device 11005, and to execute operations as follows. The processor 11005, through the network interface 11004, reports location information and the effective transaction range to the payment server for the payment server to store the location information and the effective transaction range to form the transaction region information of the transaction client terminal.

As such, the exemplary transaction client terminal depicted in FIG. 11 can achieve the double safety verification through the facial image information and through the location information of the payer. In addition, only after the double safety verification, the operation of the process can be allowed. The payment security can be significantly improved. Further, the exemplary transaction client terminal depicted in FIG. 11 can allow the payment methods to be performed with eliminated, tedious operations caused by manual input of the payment password(s) by the payer. The payment operation can be simplified. Payment efficiency can be improved.

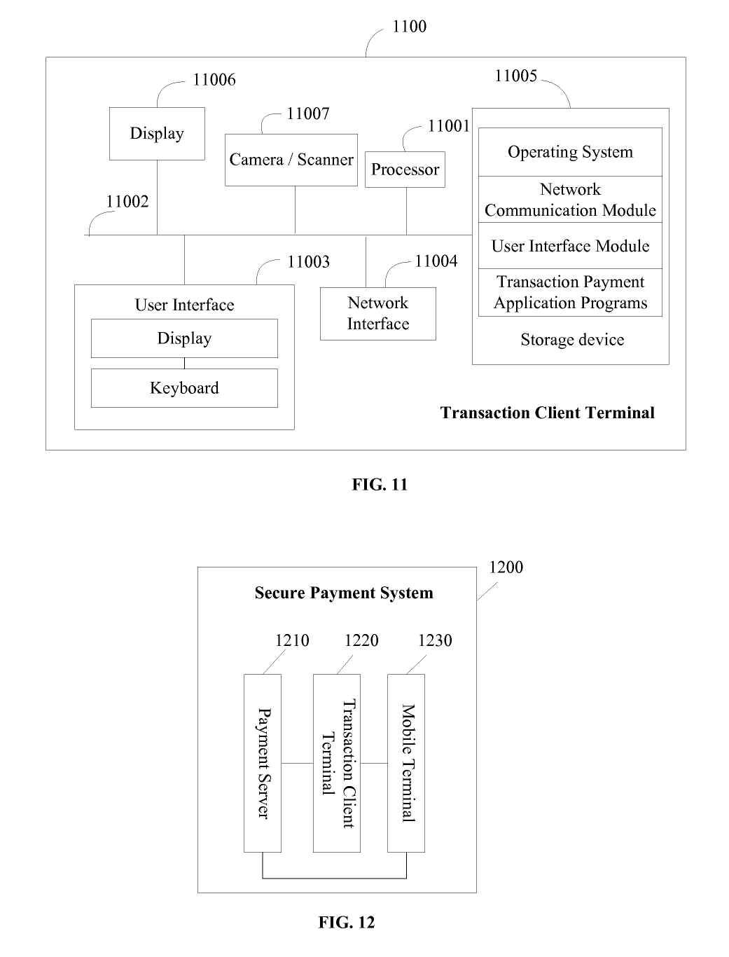

FIG. 12 depicts an exemplary secure payment system consistent with various disclosed embodiments. The exemplary system 1200 includes: a payment server 1210, a transaction client terminal 1220, and a mobile terminal 1230.

The payment server 1210 is the payment server of the above embodiment.

The transaction client terminal 1220 is the transaction client terminal of the above embodiment.

The mobile terminal 1230 is a current mobile terminal used by the payer of the embodiment, and is configured to provide the location information of the payer to the payment server 1210. The mobile terminal 1230 includes, but is not limited to, the user's mobile phone, the personal digital assistant, and other portable mobile terminal.

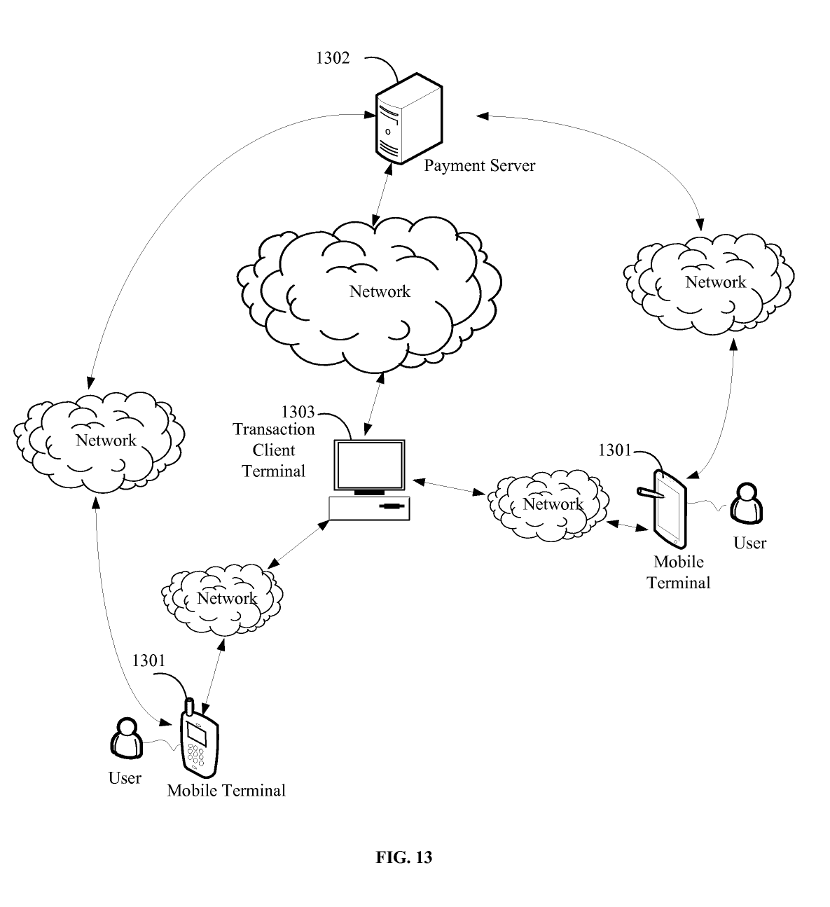

FIG. 13 depicts another exemplary secure payment system consistent with various disclosed embodiments. As depicted in FIG. 13, the exemplary secure payment system can include mobile terminals 1301, a payment server 1302, and a transaction client terminal 1303. The mobile terminal 1301 can be connected to the payment server 1302 and the transaction client terminal 1303 via the network.

The mobile terminal 1301 may be referred to the mobile terminal of the above described embodiment, configured to provide the location information of the payer to the payment server 1302.

The transaction client terminal 1303 can be the combination of the transaction client terminals in above FIG. 10 and FIG. 11, configured to acquire facial image information of the payer according to a payment instruction; to generate a payment request according to the facial image information of the payer, the payment request containing transaction ordering information and the facial image information of the payer currently acquired by the transaction client terminal; and to send the payment request to the payment server 1302 according to the payment instruction.

The payment server 1302 may be the combination of the payment servers in FIG. 4 to FIG. 9, configured to receive a payment request submitted by a transaction client terminal 1303, to recognize the facial image information of the payer to obtain user identification information of the payer, to acquire location information of the payer according to the user identification information of the payer, to determine whether the payer is located within a transaction region of the transaction client terminal according to the location information of the payer, and to process a payment transaction according to a payment confirmation message returned from the payer, when the payer is determined to be located within the transaction region. The specific implementation can be referred to the detailed structure of the payment servers of the above embodiments.

In summary, as disclosed, by containing the facial image information of the payer in the payment request, and by recognizing and confirming the transaction region to perform the payment process, double safety verification can be provided through the facial image information and through the location information of the payer. In addition, only after the double safety verification, the operation of the payment process can be allowed. The disclosed methods thus solve problems including that the personal identity code is hard to be memorized and/or vulnerable to be stolen. Payment safety is therefore significantly improved. During the transaction process, the user can complete the payment process without operations including entering the personal identity code, etc. The transaction payment process is more convenient and the payment efficiency is improved.

It should be noted that, in the present disclosure each embodiment is progressively described, i.e., each embodiment is described and focused on difference between embodiments. Similar and/or the same portions between various embodiments can be referred to with each other. In addition, exemplary apparatus is described with respect to corresponding methods.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a” does not exclude other elements included in the process, method, article, or apparatus having those elements.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In the disclosed methods, apparatus and systems for secure payment, by containing the facial image information of the payer in the payment request, and by recognizing and confirming the transaction region to perform the payment process, double safety verification can be provided through the facial image information and through the location information of the payer. In addition, only after the double safety verification, the operation of the payment process can be allowed.

The disclosed methods, apparatus and systems thus solve problems including that the personal identity code is hard to be memorized and/or vulnerable to be stolen. Payment safety is therefore significantly improved. During the transaction process, the user can complete the payment process without operations including entering the personal identity code, etc. The transaction payment process is more convenient and the payment efficiency is improved.

What is claimed is:

1. A secure payment method, comprising:
receiving, by a payment server, a payment request submitted by a transaction client terminal, the payment request containing transaction ordering information and facial image information of a payer currently acquired by the transaction client terminal;
obtaining, by the payment server, user identification information of the payer according to a recognition of the facial image information of the payer;
obtaining, by the payment server, location information of the payer according to the user identification information of the payer;
determining, by the payment server, whether the payer is located within a transaction region of the transaction client terminal according to the location information of the payer; and
processing, by the payment server, a payment transaction according to the payment confirmation message returned from the payer, when the payer is determined to be located within the transaction region.

2. The method according to claim 1, wherein obtaining, by the payment server, the user identification information of the payer according to the recognition of the facial image information of the payer includes:
calling, by the payment server, pre-stored facial image information of a payment user, wherein the pre-stored facial image information of the payment user corresponds to the user identification information of the payment user;
matching the recognition of the acquired facial image information of the payer with the pre-stored facial image information of the payment user;
when the matching of the recognition is successful, acquiring user identification information corresponding to the facial image information of the payment user that is matched successfully as the user identification information of the payer.

3. The method according to claim 1, wherein obtaining, by the payment server, the location information of the payer according to the user identification information of the payer, includes:
sending, by the payment server, a location request message to the payer according to the user identification information of the payer; and receiving, by the payment server, the location information returned from the payer according to the location request message.

4. The method according to claim 1, wherein obtaining, by the payment server, the location information of the payer according to the user identification information of the payer, includes:
timedly receiving, by the payment server, the location information sent by the payer; and finding, by the payment server, the location information of the payer from the received location information according to the user identification information of the payer.

5. The method according to claim 1, wherein determining, by the payment server, whether the payer is located within a transaction region of the transaction client terminal according to the location information of the payer includes:
calling, by the payment server, pre-stored transaction region information of the transaction client terminal;
matching the acquired location information of the payer with the pre-stored transaction region information of the transaction client terminal; and
when the matching is successful, determining that a location of the payer is within the transaction region of the transaction client terminal.

6. The method according to claim 1, wherein processing, by the payment server, the payment transaction according to the payment confirmation message returned from the payer includes:
sending, by the payment server, a payment confirmation requesting message to the payer according to the payment request, the payment confirmation requesting message containing the transaction ordering information; and
processing, by the payment server, the payment transaction according to the payment confirmation message returned from the payer.

7. The method according to claim 1, further comprising:
acquiring, by the transaction client terminal, the facial image information of the payer according to a payment instruction, wherein the payer is a current payer;
generating, by the transaction client terminal, the payment request according to the facial image information of the payer; and
sending, by the transaction client terminal, the payment request to the payment server.

8. The method according to claim 7, further including:
reporting, by the transaction client terminal, location information of the transaction client terminal to the payment server for the payment server to store the location information of the transaction client terminal to form transaction region information of the transaction client terminal.

9. A payment system, comprising a payment server, the payment server comprising:
a payment request receiving module, configured to receive a payment request submitted by a transaction client terminal, the payment request containing transaction ordering information and facial image information of a payer currently acquired by the transaction client terminal;
a recognizing module, configured to recognize the facial image information of the payer to obtain user identification information of the payer;
a location information acquiring module, configured to acquire location information of the payer according to the user identification information of the payer;
a determining module, configured to determine whether the payer is located within a transaction region of the transaction client terminal according to the location information of the payer; and
a payment processing module, configured to, process a payment transaction according to a payment confirmation message returned from the payer, when the payer is determined to be located within the transaction region.

10. The payment system according to claim 9, wherein the recognizing module includes:
a facial image calling unit, configured to call pre-stored facial image information of a payment user, wherein the pre-stored facial image information of the payment user corresponds to the user identification information of the payment user;
a recognition matching unit, configured to match the recognition of the facial image information of the payer with the pre-stored facial image information of the payment user; and
an acquiring unit, configured, when the matching of the recognition is successful, to acquire user identification information corresponding to facial image information of a payment user that is matched successfully as the user identification information of the payer.

11. The payment system according to claim 9, wherein the location information acquiring module includes:
a sending and receiving unit, configured to send a location request message to the payer according to the user identification information of the payer; and to receive the location information returned from the payer according to the location request message.

12. The payment system according to claim 9, wherein the location information acquiring module includes:
a receiving and finding unit, configured to timedly receive the location information sent by the payer; and to find the location information of the payer from the received location information according to the user identification information of the payer.

13. The payment system according to claim 9, wherein the determining module includes:
a transaction region calling unit, configured to call pre-stored transaction region information of the transaction client terminal; and
a matching and determining unit, configured to match the acquired location information of the payer with the pre-stored transaction region information of the transaction client terminal, and, when the matching is successful, to determine that a location of the payer is within the transaction region of the transaction client terminal.

14. The payment system according to claim 9, wherein the payment processing module includes:
a payment confirmation sending unit, configured to send a payment confirmation requesting message to the payer according to the payment request, the payment confirmation requesting message containing the transaction ordering information; and
a payment confirmation processing unit, configured to process the payment transaction according to the payment confirmation message returned from the payer.

15. The payment system according to claim 9, further comprising the transaction client terminal, wherein the transaction terminal includes:
a facial image information acquiring module configured to acquire the facial image information of the payer according to a payment instruction;
a payment request generating module configured to generate the payment request according to the facial image information of the payer; and
a payment request sending module configured to send the payment request to the payment server according to the payment instruction.

16. The payment system according to claim 15, further including:
a location reporting module configured to report location information of the transaction client terminal to the payment server for the payment server to store the location information of the transaction client terminal to form transaction region information of the transaction client terminal.

17. A non-transitory computer-readable medium having computer program for, when being executed by a processor, performing a method for a payment system including a payment server and a transaction client terminal, the method comprising:
receiving a payment request submitted by the transaction client terminal, the payment request containing transaction ordering information and facial image information of a payer currently acquired by the transaction client terminal;
obtaining user identification information of the payer according to a recognition of the facial image information of the payer;
obtaining location information of the payer according to the user identification information of the payer;
determining whether the payer is located within a transaction region of the transaction client terminal according to the location information of the payer; and
processing a payment transaction according to the payment confirmation message returned from the payer, when the payer is determined to be located within the transaction region.

18. The computer-readable medium according to claim 17, wherein obtaining the user identification information of the payer according to the recognition of the facial image information of the payer includes:
calling pre-stored facial image information of a payment user, wherein the pre-stored facial image information of the payment user corresponds to the user identification information of the payment user;
matching the recognition of the acquired facial image information of the payer with the pre-stored facial image information of the payment user;
when the matching of the recognition is successful, acquiring user identification information corresponding to the facial image information of the payment user that is matched successfully as the user identification information of the payer.

19. The computer-readable medium according to claim 17, wherein obtaining the location information of the payer according to the user identification information of the payer, includes:
sending a location request message to the payer according to the user identification information of the payer; and receiving the location information returned from the payer according to the location request message.

20. The computer-readable medium according to claim 17, wherein obtaining the location information of the payer according to the user identification information of the payer, includes:
receiving the location information sent by the payer; and finding the location information of the payer from the received location information according to the user identification information of the payer.
